(19) United States
(12) Patent Application Publication
(10) Pub. No.: US 2014/0265714 A1
(43) Pub. Date: Sep. 18, 2014

(54) TRANSVERSE FLUX STATOR CORE MANUFACTURE

(71) Applicant: REMY TECHNOLOGIES, L.L.C., Pendleton, IN (US)

(72) Inventor: Andrew Meyer, Fishers, IN (US)

(73) Assignee: REMY TECHNOLOGIES, L.L.C., Pendleton, IN (US)

(21) Appl. No.: 13/800,302

(22) Filed: Mar. 13, 2013

(51) Int. Cl. H02K 15/02; H02K 1/14; H02K 1/12

(52) U.S. Cl. CPC H02K 15/022; H02K 1/12; H02K 1/141
USPC 310/216.039; 310/216.054; 29/596

(57) ABSTRACT

A transverse flux stator core is provided and includes laminations. Each of the laminations has a desired profile and is non-planar. The laminations are bonded in a stacked, aligned arrangement.

### BACKGROUND OF THE INVENTION

The subject matter disclosed herein relates to a method of manufacturing a transverse flux stator core.

In a transverse flux machine, a central rotor (or “coreback”) is equipped with a series of permanent magnets that are arranged circumferentially in an alternating north-south configuration. The central rotor and the permanent magnets are surrounded by a circumferential coil that extends through a series of circumferentially arranged stator cores 10. During operation, the rotor may be rotated about its longitudinal axis whereby the permanent magnets induce a magnetic flux in the stator cores 10, which in turn generates a current in the coil. Conversely, if current is applied to the coil, the current induces a flux in the stator cores 10 that causes the permanent magnets and the rotor to rotate.

### BRIEF DESCRIPTION OF THE INVENTION

According to one aspect of the invention, a transverse flux stator core is provided and includes laminations. Each of the laminations has a desired profile and is non-planar. The laminations are bonded in a stacked, aligned arrangement.

According to another aspect of the invention, a method of manufacturing a transverse flux stator core is provided and includes shaping laminations to a desired profile, non-planarizing the shaped laminations and bonding the non-planarized shaped laminations in a stacked, aligned arrangement.

According to yet another aspect of the invention, a method of manufacturing a transverse flux stator core is provided and includes shaping laminations to a desired profile, bonding the shaped laminations in a stacked, aligned arrangement and non-planarizing the stacked, aligned arrangement of bonded shaped laminations.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a plan view of a stator core;

FIG. 2 is an elevational view of the stator core of FIG. 1;

FIG. 3 is a side view of the stator core of FIG. 1; and

FIG. 4 is a side view of a stator core in accordance with alternative embodiments.

The detailed description explains embodiments of the invention, together with advantages and features, by way of example with reference to the drawings.

### DETAILED DESCRIPTION OF THE INVENTION

With reference to FIGS. 1-3, a transverse flux stator core 10 is provided for use in, for example, a transverse flux machine (TFM). In a transverse flux machine, a central rotor (or “coreback”) is equipped with a series of permanent magnets that are arranged circumferentially in an alternating north-south configuration. The central rotor and the permanent magnets are surrounded by a circumferential coil that extends through a series of circumferentially arranged stator cores 10. During operation, the rotor may be rotated about its longitudinal axis whereby the permanent magnets induce a magnetic flux in the stator cores 10, which in turn generates a current in the coil. Conversely, if current is applied to the coil, the current induces a flux in the stator cores 10 that causes the permanent magnets and the rotor to rotate.

Each of the stator cores 10 may be formed of a similar process and the following description will therefore relate to the formation of a single one (i.e., “the stator core 10”) of the stator cores 10. Such formation leads to the stator core 10 including laminations 11. Each of the laminations 11 may have a desired profile 12, such as a U-shape as shown in FIGS. 1-3 or a C-shape, and may be bonded to one or more adjacent laminations 11 in a stacked, aligned arrangement 13. Typically, each of the laminations in stator core element will be planarized whereby the cross-section of the stator core element will be rectangular. In accordance with various embodiments, however, each of the laminations 11 is non-planar (or non-planarized) as will be described below such that the stator core 10 may be non-rectangular or, in some cases, substantially rectangular.

In accordance with embodiments, the laminations 11 may be initially shaped to the desired profile 12 (e.g., the U-shape or the C-shape) by at least one or more of machining and punching. A result of the shaping is shown in FIG. 1, which is an illustration of the U-shape of the desired profile 12 and indicates that each of the laminations 11 may have multiple transverse sections 110 of substantially similar and uniform planar thicknesses, T. Once the laminations 11 are shaped, the shaped laminations 11 are non-planarized and the set of non-planarized laminations 11 are bonded in the stacked, aligned arrangement 13. The bonding may include a heat and/or pressure treatment and may further include at least one or more of welding processes and adhesive applications.

With reference to FIGS. 2 and 3, the non-planarizing of the shaped laminations 11 may include bending portions of the shaped laminations 11 on opposite sides thereof in opposite directions. That is, for the embodiment in which the desired profile 12 is the U-shape, each of the shaped laminations 11 has a main transverse section 20 and transverse leg sections 21 that extend in similar planar directions from opposite distal ends of the main transverse section 20. The proximal portions 210 of the transverse leg sections 21 are then bent in opposite directions, as shown in FIGS. 2 and 3.

With reference to FIG. 4, a cross-section 30 of the stator core may be substantially rectangular even where the laminations 11 are non-planar. This can be achieved by providing the laminations 11 in a given stator core 10 with varying dimensions, as shown in FIG. 4. Once the stator core 10 is formed with the shaped laminations 11 bonded in the stacked, aligned arrangement 13, the varying dimensions of the laminations 11 result in the stator core 10 having the substantially rectangular cross-section 30.

In accordance with alternative embodiments, the shaping of the laminations 11 to the desired profile 12 and the bonding of the shaped laminations 11 in the stacked, aligned arrangement 13 may be completed prior to the non-planarization. In these alternative embodiments, the non-planarization is completed for all of the laminations 11 in the stator core 10 as a group once the bonding is completed.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A transverse flux stator core, comprising:
laminations each having a desired profile and being bonded in a stacked, aligned arrangement,
each of the laminations being non-planar.

2. The transverse flux stator core according to claim 1, wherein the desired profile of each of the laminations is at least one of a U-shape and a C-shape.

3. The transverse flux stator core according to claim 1, wherein each of the laminations has a substantially uniform thickness along multiple transverse sections.

4. The transverse flux stator core according to claim 1, wherein a cross-section of the stacked, aligned arrangement of the bonded laminations is substantially rectangular.

5. A method of manufacturing a transverse flux stator core, comprising:
shaping laminations to a desired profile;
non-planarizing the shaped laminations; and
bonding the non-planarized shaped laminations in a stacked, aligned arrangement.

6. The method according to claim 5, wherein the desired profile is at least one of a U-shape and a C-shape.

7. The method according to claim 5, wherein the shaped laminations have a substantially uniform thickness along multiple transverse sections.

8. The method according to claim 5, wherein the shaping comprises at least one of machining and punching.

9. The method according to claim 5, wherein the non-planarizing comprises bending portions of the shaped laminations on opposite sides thereof in opposite directions.

10. The method according to claim 5, wherein the desired profile is a U-shape and the non-planarizing comprises bending corresponding portions of each lamination leg in opposite directions.

11. The method according to claim 5, wherein the bonding comprises at least one or welding and applying adhesive.

12. The method according to claim 5, further comprising forming the laminations with varying dimensions such that the stacked, aligned arrangement of the bonded laminations has a substantially rectangular cross-section.

13. A method of manufacturing a transverse flux stator core, comprising:
shaping laminations to a desired profile;
bonding the shaped laminations in a stacked, aligned arrangement; and
non-planarizing the stacked, aligned arrangement of bonded shaped laminations.

14. The method according to claim 13, wherein the desired profile is at least one of a U-shape and a C-shape.

15. The method according to claim 13, wherein the shaped laminations have a substantially uniform thickness along multiple transverse sections.

16. The method according to claim 13, wherein the shaping comprises at least one of machining and punching.

17. The method according to claim 13, wherein the bonding comprises at least one or welding and applying adhesive.

18. The method according to claim 13, wherein the non-planarizing comprises bending portions of the stacked, aligned arrangement of the bonded shaped laminations on opposite sides thereof in opposite directions.

19. The method according to claim 13, wherein the desired profile is a U-shape and the non-planarizing comprises bending corresponding portions of each leg of the stacked, aligned arrangement of the bonded shaped laminations in opposite directions.

20. The method according to claim 13, further comprising forming the laminations with varying dimensions such that the stacked, aligned arrangement of the bonded laminations has a substantially rectangular cross-section.
